(19) United States
(12) Patent Application Publication
(10) Pub. No.: US 2023/0178315 A1
(43) Pub. Date: Jun. 8, 2023

(54) VACUUM VALVE

(71) Applicant: Mitsubishi Electric Corporation, Chiyoda-ku, Tokyo (JP)

(72) Inventor: Yusuke NISHIMURA, Tokyo (JP)

(73) Assignee: Mitsubishi Electric Corporation, Chiyoda-ku, Tokyo (JP)

(21) Appl. No.: 17/997,034

(22) PCT Filed: Jun. 17, 2020
(86) PCT No.: PCT/JP2020/023815

§ 371 Date: Oct. 25, 2022

(51) Int. Cl. H01H 33/664; H01H 33/666; H01H 33/662

(52) U.S. Cl. CPC H01H 33/6643; H01H 33/666; H01H 33/66207

(57) ABSTRACT

A vacuum valve includes: an insulation container; a fixed-side electrode including a fixed-side contact, a fixed-side longitudinal magnetic-field coil generating a magnetic field on a surface of the fixed-side contact in an axial direction, and a fixed-side spacer; and a movable-side electrode including a movable-side contact, a movable-side longitudinal magnetic-field coil generating a magnetic field on a surface of the movable-side contact in the axial direction, and a movable-side spacer. The fixed-side longitudinal magnetic-field coil and the movable-side longitudinal magnetic-field coil each include an outer ring portion having an arc shape and a power feeding portion protruding from an end of the outer ring portion. The fixed-side or movable-side contact is brazed to the power feeding portion. The fixed-side and movable-side spacers are made of a material with lower conductivity than materials of the fixed-side and movable-side longitudinal magnetic-field coils, or made of an insulator.

### FIELD

The present disclosure relates to a vacuum valve to be used for arc-extinguishing chambers of a vacuum circuit breaker and a vacuum switch.

### BACKGROUND

A vacuum valve is used for arc-extinguishing chambers of a vacuum circuit breaker and a vacuum switch. The vacuum valve has a fixed electrode and a movable electrode accommodated within a cylindrical insulation container. Each of the fixed electrode and the movable electrode includes a contact, a longitudinal magnetic-field coil, a support, and an electrode rod. Both end portions of the insulation container are closed by end plates, and the electrode rod of the movable electrode penetrates the end plate and extends to the outside of the insulation container. A bellows is provided for the electrode rod of the movable electrode, so that an opening action and a closing action can be performed while the inside of the insulation container is maintained under vacuum.

When the vacuum valve is assembled, a foil-like or wire-like brazing material is disposed between parts for each of the fixed electrode and the movable electrode, and the brazing material is heated, melted, and solidified to perform partial brazing. The fixed electrode and the movable electrode having been partially brazed are coaxially disposed inside the insulation container, and final brazing is performed in a vacuum furnace, whereby the fixed electrode and the movable electrode are disposed in a vacuum.

Patent Literature 1 discloses a vacuum valve that includes a longitudinal magnetic-field coil including an inner ring portion, a spoke portion, and an outer ring portion. The inner ring portion is fixed to a fixed shaft. The spoke portion extends in a radial direction from the inner ring portion. The outer ring portion extends in an arc shape in a circumferential direction from an end of the spoke portion. A protrusion called a power feeding portion is provided at an end of the outer ring portion, and a contact is brazed to the power feeding portion. The longitudinal magnetic-field coil generates en axial magnetic field on a surface of the contact when an electric current flows through the outer ring portion. Since magnetic fields generated on surfaces of the contacts trap and diffuse electrons forming an arc generated between the contacts, a local rise in temperature of the contact is prevented, and electric current interruption performance is improved.

### CITATION LIST

### Patent Literature

Patent Literature 1: Japanese Patent Application Laid-open No S59-42735 (JP S5942735 A)

### SUMMARY

### Technical Problem

The vacuum valve disclosed in Patent Literature 1 includes a plurality of outer ring portions separated from each other by a slit, extending in a radial direction, and the outer ring portions are arranged in form of a ring that is partially missing. Therefore, around the slit, the axial magnetic field is weakened on the surface of the contact, so that arc becomes difficult to diffuse. It is possible to reduce the number of portions in each of which the axial magnetic field is weakened on the surface of the contact, by providing a single outer ring portion to reduce the number of slits. However, since the power feeding portion is provided only at one place, the contact cannot be stably supported by the longitudinal magnetic-field coil, and assemblability is deteriorated accordingly.

The present disclosure has been made in view of the above circumstances, and an object of the present disclosure is to provide a vacuum valve having a smaller number of portions in each of which an axial magnetic field is weakened on a surface of a contact and being easier to assemble.

### Solution to Problem

In order to solve the above-described problem and achieve the object, the present disclosure provides a vacuum valve comprising: an insulation container with a cylindrical shape; and a fixed-side electrode and a movable-side electrode installed on a central axis of the insulation container in such a way as to face each other, wherein the fixed-side electrode includes a fixed-side contact, a fixed-side longitudinal magnetic-field coil, and a fixed-side spacer, the fixed-side longitudinal magnetic-field coil generating a magnetic field on a surface of the fixed-side contact in an axial direction of the insulation container, the fixed-side spacer filling a gap between the fixed-side contact and the fixed-side longitudinal magnetic-field coil, the movable-side electrode includes a movable-side contact, a movable-side longitudinal magnetic-field coil, and a movable-side spacer, the movable-side longitudinal magnetic-field coil generating a magnetic field on a surface of the movable-side contact in the axial direction of the insulation container, the movable-side spacer filling a gap between the movable-side contact and the movable-side longitudinal magnetic-field coil, the fixed-side longitudinal magnetic-field coil and the movable-side longitudinal magnetic-field coil each include an inner ring portion, a spoke portion, an outer ring portion, and a power feeding portion, the inner ring portion being disposed at a central part of the insulation container in a radial direction, the spoke portion extending from the inner ring portion in the radial direction of the insulation container, the outer ring portion extending in an arc shape in a circumferential direction of the insulation container, an end of the outer ring portion being separated from the spoke portion by a slit extending along the radial direction of the insulation container, the power feeding portion protruding from the end in the axial direction of the insulation container, the fixed-side contact or the movable-side contact being brazed to the power feeding portion, and the fixed-side spacer and the movable-side spacer are made of a material having a lower electric conductivity than a material of the fixed-side longitudinal magnetic-field coil and a material having a lower electric conductivity than a material of the movable-side longitudinal magnetic-field coil, respectively, or made of an insulator, each of the fixed-side spacer and the movable-side spacer being installed on at least one portion of the outer ring portion.

### Advantageous Effects of Invention

The present disclosure achieves an advantageous effect that it can provide a vacuum valve having a smaller number of portions where axial magnetic fields are weakened on surfaces of contacts and being easier to assemble.

### BRIEF DESCRIPTION OF DRAWINGS

FIG. 1 is a cross-sectional view of a vacuum valve according to a first embodiment:

FIG. 2 is a cross-sectional view of an electrode unit of the vacuum valve according to the first embodiment.

FIG. 3 is a perspective view of the electrode unit of the vacuum valve according to the first embodiment.

FIG. 4 is an exploded perspective view of the electrode unit of the vacuum valve according to the first embodiment.

FIG. 5 is a plan view of a fixed-side longitudinal magnetic-field coil and a movable-side longitudinal magnetic-field coil of the vacuum valve according to the first embodiment.

FIG. 6 is a diagram illustrating a state in which fixed-aide spacers have been attached to the fixed-side longitudinal magnetic-field coil of the vacuum valve according to the first, embodiment and a state in which movable-aide spacers have been attached to the movable-side longitudinal magnetic-field coil of the same.

FIG. 7 is a cross-sectional view of an electrode unit of a vacuum valve according to a first modification of the first embodiment.

FIG. 8 is an exploded perspective view of the electrode unit of the vacuum valve according to the first modification of the first embodiment.

FIG. 9 is a cross-sectional view of an electrode unit of a vacuum valve according to a second modification of the first embodiment.

FIG. 10 is a cross-sectional view of an electrode unit of a vacuum valve according to a third modification of the first embodiment.

FIG. 11 is a cross-sectional view of an electrode unit of a vacuum valve according to a second embodiment.

FIG. 12 is an exploded perspective view of the electrode unit of the vacuum valve according to the second embodiment.

FIG. 13 is a diagram illustrating a state in which a fixed-side spacer has been attached to a fixed-side longitudinal magnetic-field coil of the vacuum valve according to the second embodiment and a state in which a movable-side spacer has been attached to a movable-side longitudinal magnetic-field coil of the same.

FIG. 14 is a cross-sectional view of an electrode unit of a vacuum valve according to a third embodiment.

FIG. 15 is an exploded perspective view of the electrode unit of the vacuum valve according to the third embodiment.

FIG. 16 is a diagram illustrating a state in which a fixed-side spacer has been attached to a fixed-side longitudinal magnetic-field coil of the vacuum valve according to the third embodiment and a state in which a movable-side spacer has been attached to a movable-side longitudinal magnetic-field coil of the same.

### DESCRIPTION OF EMBODIMENTS

Hereinafter, a vacuum valve according to each embodiment will be described in detail with reference to the drawings.

### First Embodiment

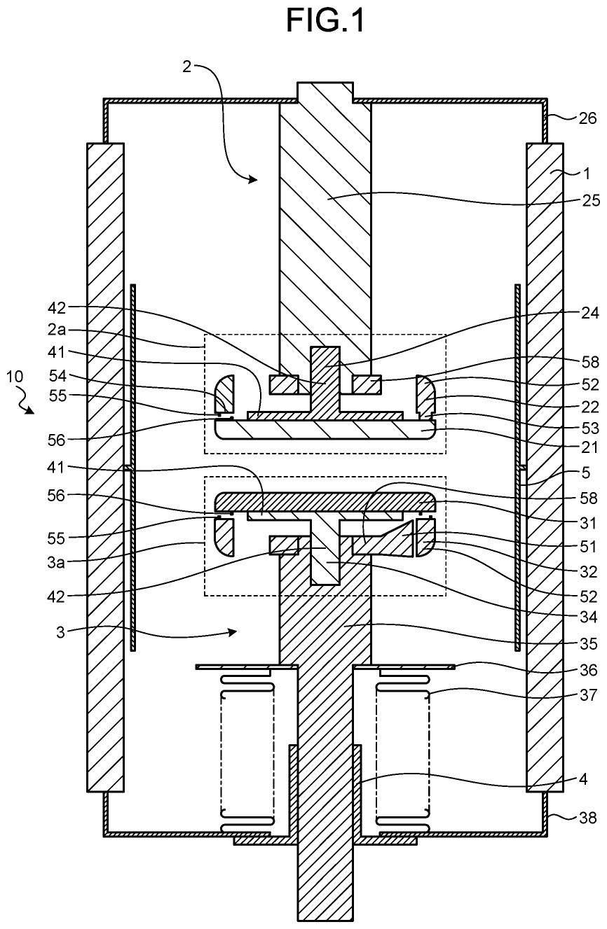

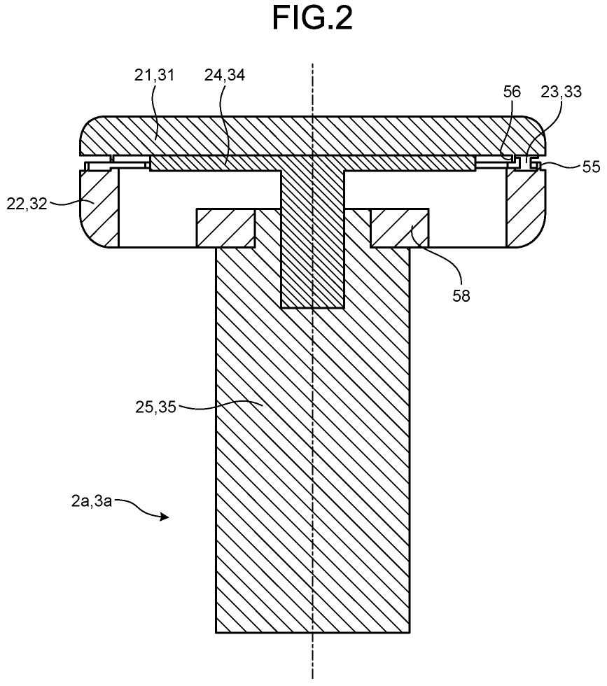

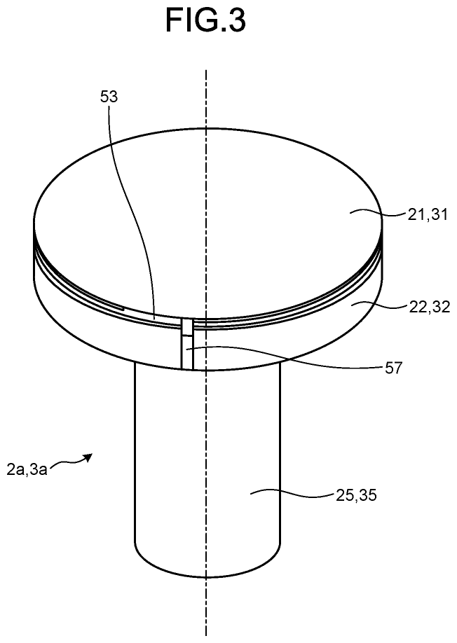

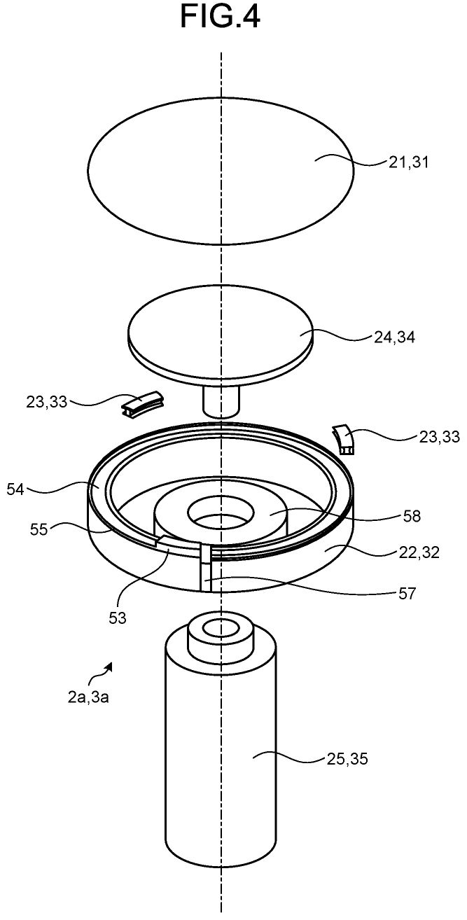

FIG. 1 is a cross-sectional view of a vacuum valve according to a first embodiment. FIG. 2 is a cross-sectional view of an electrode unit of the vacuum valve according to the first embodiment. FIG. 3 is a perspective view of the electrode unit of the vacuum valve according to the first embodiment FIG. 4 is an exploded perspective view of the electrode unit of the vacuum valve according to the first embodiment. A vacuum valve 10 includes an insulation container 1 with a tubular shape, and a fixed side electrode 2 and a movable-side electrode 3 that are coaxially arranged on a central axis of the insulation container 1. Hereinafter, unless otherwise specified, an “axial direction” refers to an axial direction of the insulation container 1, a “radial direction” refers to a radial direction of the insulation container 1, and a “circumferential direction” refers to a circumferential direction of the insulation container 1.

The fixed-side electrode 2 includes a fixed-side contact 21, a fixed-side longitudinal magnetic-field coil 2.2, fixed-side spacers 23, a fixed-side support 24, a fixed-side electrode rod 25, and a fixed-side end plate 26. The fixed-side longitudinal magnetic-field coil 22 generates an axial magnetic field on a surface of the fixed-side contact 21. The fixed-side spacers 23 fill a gap between the fixed-side contact 21 and the fixed-side longitudinal magnetic-field coil 22 The fixed-side support 24 supports the fixed-side contact 21, The fixed-side end plate 26 closes one end portion of the insulation container 1. The movable-side electrode 3 includes a movable-side contact 31, a movable-side longitudinal magnetic-field coil 32 movable-side spacers 33, a movable-side support 34, a movable-side electrode rod 35, a bellows cover 36, a bellows 37, and a movable-side end plate 38. The movable-side longitudinal magnetic-field coil 32 generates an axial magnetic field on a surface of the movable-side contact 31. The movable-side spacers 33 fill a gap between the movable-side contact 31 and the movable-side longitudinal magnetic-field coil 32. The movable-side support 34 supports the movable-side contact 31. The movable-side electrode rod 35 moves along the axial direction during an opening action and a closing action under power transmitted from an open and closing device (not illustrated). The movable-side end plate 38 closes another end portion of the insulation container 1.

The bellows cover 36 with a disk shape is attached to the movable-side electrode rod 35. The movable-side end plate 38 and the bellows cover 36 are connected by the bellows 37. The bellows 37 covers the movable-side electrode rod 35 from the radial direction. The bellows 37 is capable of expanding and contracting in the axial direction, and expands and contracts in accordance with the movement of the movable-side electrode rod 35 during the opening action and the closing action. A guide 4 for guiding the movable-side electrode rod 35 is set on the movable-side end plate 38.

An electrode unit 2a that is an end portion of the fixed-side electrode 2 and an electrode unit 3a that is an end portion of the movable-side electrode 3 are opposed to each other. The fixed-side electrode 2 and the movable-side electrode 3 have their equal structures. However, since the fixed-side longitudinal magnetic-field coil 22 and the movable-side longitudinal magnetic-field coil 32 have their different orientations in the circumferential direction, the illustrated cross-sectional shapes of the fixed-aide longitudinal magnetic-field coil 22 and the movable-side longitudinal magnetic-field coil 32 are also different in FIG. 1. The vacuum valve 10 performs an opening action and a closing action. In the opening action, the movable-side contact 31 that has been in contact with the fixed-side contact 21 is separated from the fixed-side contact 21. In the closing action, the movable-side contact 31 that has been separated from the fixed-side contact 21 is brought into contact with the fixed-side contact 21.

One end of the fixed-side electrode rod 25 is fixed to the fixed-side end plate 26. The fixed-side support 24 is attached to another end of the fixed-side electrode rod 25. The fixed-side support 24 includes a circular disk portion 41 and a shaft portion 42 protruding from one surface of the circular disk portion 41. The fixed-side support 24 is surrounded by the fixed-side longitudinal magnetic-field coil 22 from the outer peripheral side. The fixed-side contact 21 is brazed to a surface opposite to a surface of the circular disk portion 41 of the fixed-side support 24 from which the shaft portion 42 protrudes.

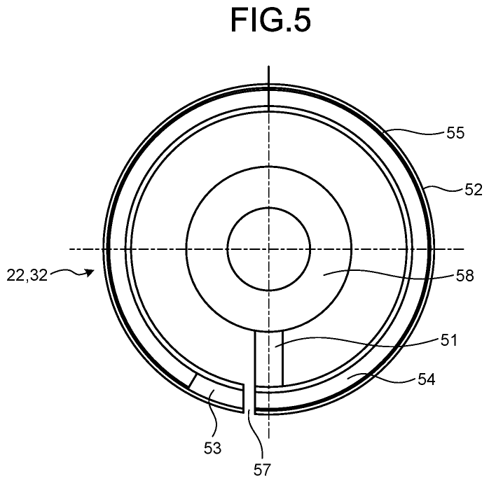

FIG. 5 is a plan view of the fixed-side longitudinal magnetic-field coil and the movable-side longitudinal magnetic-field coil of the vacuum valve according to the first embodiment. The fixed-side longitudinal magnetic-field coil 22 includes an inner ring portion 58, a spoke portion 51, and an outer ring portion 52. The inner ring portion 58 is disposed at a central part of the insulation container 1 in the radial direction. The spoke portion S1 extends in the radial direction from the inner ring portion 58. The outer ring portion 52 extends in an arc shape in the circumferential direction from a leading end of the spoke portion 51. An end of the outer ring portion 52 is separated from the spoke portion 51 by a slit 57 extending along the radial direction. A power feeding portion 53 is provided at the end of the outer ring portion 52, and the fixed-side contact 21 is braced to the power feeding portion 53. The power feeding portion 53 protrudes in the axial direction from the end of the outer ring portion 52. A groove 54 is formed in an end surface of the fixed-side longitudinal magnetic-field coil 22 facing the fixed-side contact 21, The inner ring portion 58 is fixed to the fixed-side electrode rod 25.

The fixed-side longitudinal magnetic-field coil 22 is made of copper, and the fixed-side support 24 is made of a material having a lower electric conductivity than the fixed-side longitudinal magnetic-field coil 22. The fixed-side longitudinal magnetic-field coil 22 has a higher electric conductivity than the fixed-side support 24, so that an electric current more easily flows through the fixed-side longitudinal magnetic-field coil 22 than through the fixed-side support 24. Therefore, an electric current flowing between the fixed-side electrode rod 25 and the fixed-side contact 21 more easily flows through a path via the fixed-side longitudinal magnetic-field coil 22 than through a path via the fixed-side support 24.

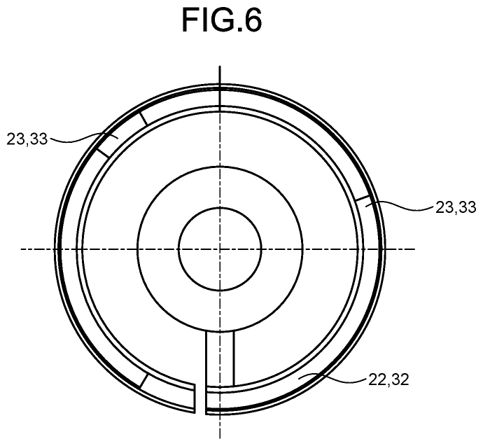

FIG. 6 is a diagram illustrating a state in which the fixed-side spacers have been attached to the fixed-side longitudinal magnetic-field coil of the vacuum valve according to the first embodiment and a state in which the movable-side spacers have been attached to the movable-side longitudinal magnetic-field coil of the same. The fixed-side spacers 23 are fitted into the groove 54. Each of the fixed-side spacers 23 has an H-shaped cross section, which is made of an insulator such as ceramic, or of metal having a lower electric conductivity than copper, such as austenitic stainless steel. The fixed-side spacers 23 fill axial gaps between the fixed-side longitudinal magnetic-field coil 22 and the fixed-side contact 21, and are in contact with both of the fixed-side longitudinal magnetic-field coil 22 and the fixed-side contact 21. Therefore, the fixed-side contact 21 is supported by the fixed-side longitudinal magnetic-field coil 22 not only via the power feeding portion 53, but also via the fixed-side spacers 23 at locations where the fixed-side spacers 23 are set.

Furthermore, the fixed-side longitudinal magnetic-field coil 22 is provided with a ridge 55 formed on the outer peripheral side of the groove 54. On the other hand, for the fixed-side contact 21, the ridge 56 formed on the inner peripheral side of a portion with which the fixed-side spacer 23 is in contact. The ridges 55 and 56 are subjected to swaging in such a way as to have the fixed-side spacer 23 interposed between the ridges 55 and 56. The fixed-side spacers 23 are not brazed, but are fixed to the fixed-side longitudinal magnetic-field coil 22 and the fixed-side contact 21 by the swaging of the ridges 55 and 55.

The movable-side electrode rod 35 penetrates the movable-side end plate 38, and one end of the movable-side electrode rod 35 protrudes out of the insulation container 1. The movable-side support 34 is attached to another end of the movable-side electrode rod 35. The movable-side support 34 includes a circular disk portion 41 and a shaft portion 42 protruding from one surface of the circular disk portion 41. The movable-side support 34 is surrounded by the movable-side longitudinal magnetic-field coil 32 from the outer peripheral side. The movable-side contact 31 is brazed to a surface opposite to a surface of the circular disk portion 41 of the movable-side support 34 from which the shaft portion 42 protrudes.

As illustrated in FIG. 5, the movable-side longitudinal magnetic-field coil 32 includes an inner ring portion 58, a spoke portion 51, and an outer ring portion 52. The inner ring portion 58 is disposed at the central part of the insulation container 1 in the radial direction. The spoke portion 51 extends in the radial direction from the inner ring portion 58. The outer ring portion 52 extends in, an arc shape in the circumferential direction from a leading end of the spoke portion 51. An end of the outer ring portion 52 is separated from the spoke portion 51 by a slit 57 extending along the radial direction. A power feeding portion 53 is provided at the end of the outer ring portion 52, and the movable-side contact 31 is brazed to the power feeding portion 53. The power feeding portion 53 protrudes in the axial direction from the end of the outer ring portion 52. That is, a groove 54 is formed in an end surface of the movable-side longitudinal magnetic-field coil 32 facing the movable-aide contact 31. The inner ring portion 58 is fixed to the movable-aide electrode rod 35.

The movable-side longitudinal magnetic-field coil 32 is made of copper, and the movable-side support 34 is made of a material having a lower electric conductivity than the movable-side longitudinal magnetic-field coil 32. The movable-side longitudinal magnetic-field coil 32 has higher electric conductivity than the movable-side support 34, so that an electric current more easily flows through the movable-side longitudinal magnetic-field coil 32 than through the movable-side support 34. Therefore, an electric current flowing between the movable-side electrode rod 35 and the movable-side contact 31 more easily flows through a path via the movable-side longitudinal magnetic-field coil 32 than through a path via the movable-side support 34.

A shield 5 is provided in the insulation container 1. The shield 5 covers the fixed-side electrode 2 and the movable-side electrode 3 from the outer peripheral side. Metal vapor is generated from the fixed-side contact 21 or the movable-side contact 31 due to an arc generated between the fixed-side contact 21 and the movable-side contact 31 at the time of the opening action. The shield 5 prevents the metal vapor thus generated from adhering to the insulation container 1 thereby to deteriorate dielectric strength between the electrodes.

The movable-Bide longitudinal magnetic-field coil 32, the movable-side spacer 33, and the movable-side contact 31 have the same structures as the fixed-side longitudinal magnetic-field coil 22, the fixed-side spacer 23, and the fixed-side contact 21, respectively. As illustrated in FIG. 6, the movable-side spacers 33 each having an H-shaped cross section are fitted into the groove 54. The movable-side spacers 33 fill gaps between the movable-side longitudinal magnetic-field coil 32 and the movable-side contact 31, and the movable-side contact 31 is supported by the movable-side longitudinal magnetic-field coil 32 not only via the power feeding portion 53, but also via the movable-side spacers 33 at locations where the movable-side spacers 33 are set.

In addition, ridges 55S and 56 formed on the movable-side longitudinal magnetic-field coil 32 and the movable-side contact 31, respectively, are subjected to swaging in such a way as to have the movable-side spacers 33 interposed between the ridges 5S and 56. The movable-side spacers 33 are not brazed, but are fixed to the movable-side longitudinal magnetic-field coil 32 and the movable-side contact 31 by the swaging of the ridges 55 and 56.

When the vacuum valve is assembled, the fixed-side spacers 23 are fitted into the groove 54 of the fixed-side longitudinal magnetic-field coil 22, and the ridge 55 on the outer peripheral portion of the fixed-side longitudinal magnetic-field coil 22 is subjected to swaging to fix the fixed-side spacers 23 to the fixed-side longitudinal magnetic-field coil 22. Furthermore, the fixed-side longitudinal magnetic-field coil 22 and the fixed-side contact 21 are in butt-contact with each other, and the ridge 56 of the fixed-side contact 21 is subjected to swaging to fix the fixed-side contact 21 to the fixed-side spacers 23. Likewise, for the movable-side longitudinal magnetic-field coil 32, the movable-side spacers 33, and the movable-side contact 31, the movable-side spacers 33 are fitted into the groove 54 of the movable-side longitudinal magnetic-field coil 32, and the ridges 55 and 56 are subjected to swaging to fix the movable-side longitudinal magnetic-field coil 32, the movable-side spacers 33, and the movable-side contact 31. Thereafter, the fixed-side contact 21, the fixed-side longitudinal magnetic-field coil 22, the fixed-side support 24, the fixed-side electrode rod 25, and the fixed-side end plate 26 are partially brazed to form the fixed-side electrode 2, and the movable-side contact 31, the movable-side longitudinal magnetic-field coil 32, the movable-side support 34, the movable-side electrode rod 35, the bellows cover 36, the bellows 37, and the movable-side end plate 38 are partially brazed to form the movable-side electrode 3. Then, the shield 5, the guide 4, the fixed-side electrode and the movable-side electrode 3 are fitted in the insulation container 1, and final brazing is performed thereon.

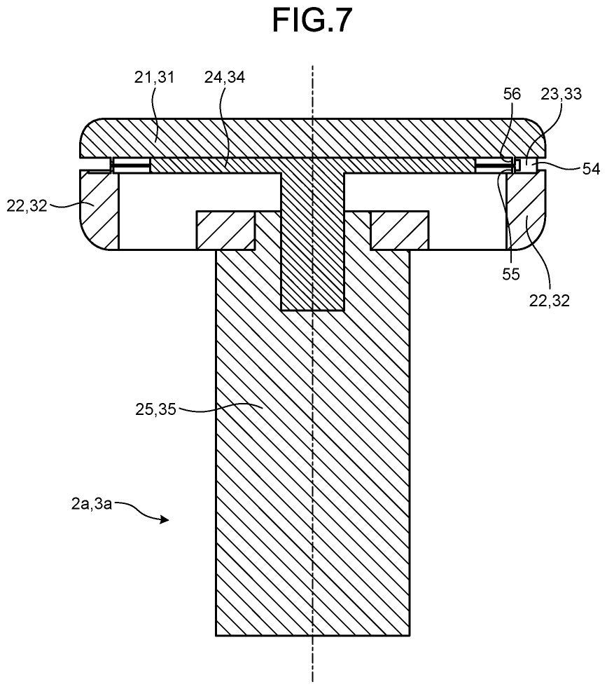

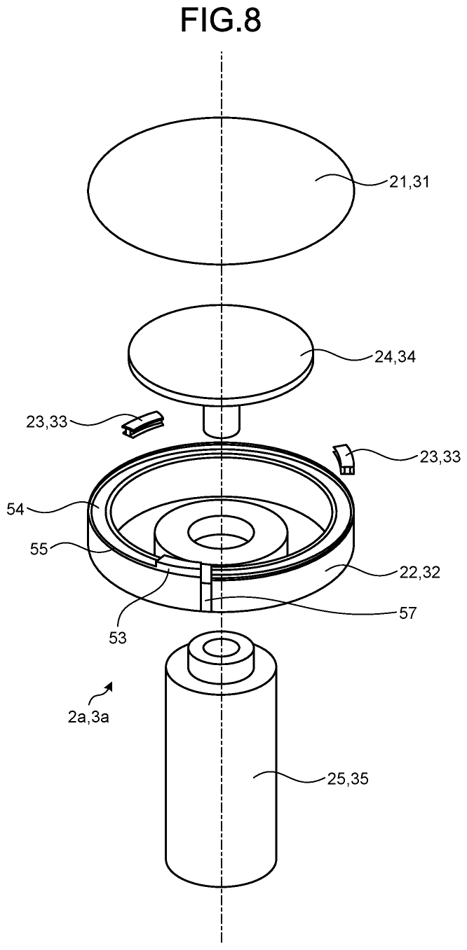

FIG. 7 is a cross-sectional view of an electrode unit of a vacuum valve according to a first modification of the first embodiment, FIG. 8 is an exploded perspective view of the electrode unit of the vacuum valve according to the first modification of the first embodiment. In the first modification of the first embodiment, the ridges 55 of the fixed-side longitudinal magnetic-field coil 22 and the movable-side longitudinal magnetic-field coil 32 are provided on the inner peripheral side of the grooves 54. Even when the ridges 55 are provided on the inner peripheral side of the grooves 54, it is possible to fix the fixed-aide spacers 23 to the fixed-side longitudinal magnetic-field coil 22 and fix the movable-side spacers 33 to the movable-side longitudinal magnetic-field coil 32 by means of swaging of the ridges 55.

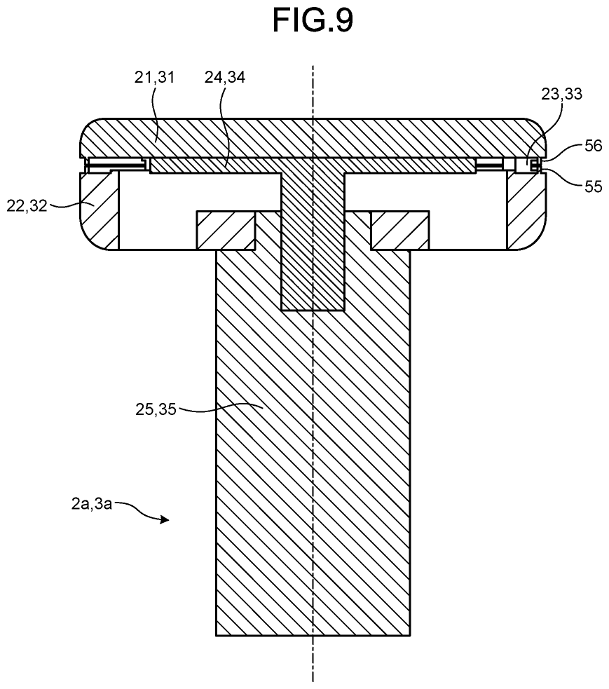

FIG. 9 is a cross-sectional view of an electrode unit of a vacuum valve according to a second modification of the first embodiment. In the second modification of the first embodiment, the ridge 56 of the fixed-side contact 21 and the ridge 56 of the movable-side contact 31 are provided on the outer peripheral side of a portion with which the fixed-side spacers 23 are in contact and a portion with which the movable-side spacers 33 are in contact, respectively. Even when the ridges 56 are provided on the outer peripheral side of the portions with which the fixed-side spacers 23 and the movable-side spacers 33 are in contact, it is possible to fix the fixed-side spacers 23 to the fixed-side contact 21 and fix the movable-side spacers 33 to the movable-side contact 31 by means of swaging of the ridges 56.

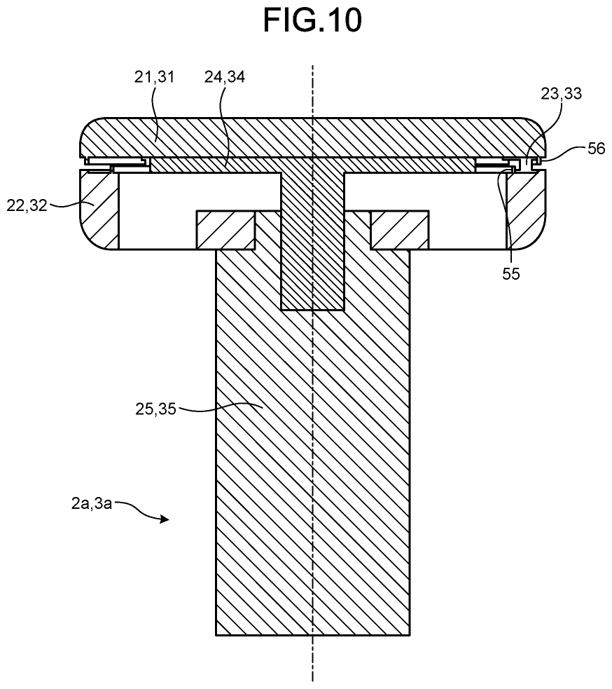

FIG. 10 is a cross-sectional view of an electrode unit of a vacuum valve according to a third modification of the first embodiment. In the third modification of the first embodiment, the ridges 55 of the fixed-side longitudinal magnetic-field coil 22 and the movable-side longitudinal magnetic-field coil 32 are provided on the inner peripheral side of the grooves 54. Furthermore, the ridge 56 of the fixed-side contact 21 and the ridge 56 of the movable-side contact 31 are provided on the outer peripheral side of portions with which the fixed-side spacers 23 and the movable-side spacers 33 are in contact, respectively. Even when the ridge 55 is provided on the inner peripheral side of the groove 54 and the ridge 56 is provided on the outer peripheral side of the portion with which the fixed-side spacer 23 or the movable-side spacer 33 is in contact, it is possible to fix the fixed-aide spacers 23 to the fixed-side longitudinal magnetic-field coil 22 and fix the movable-side spacers 33 to the movable-side longitudinal magnetic-field coil 32 by means of swaging of the ridges 55, and is also possible to fix the fixed-side spacers 23 to the fixed-side contact 21 and fix the movable-side spacers 33 to the movable-side contact 31 by means of swaging of the ridges 56.

In the vacuum valve 10 according to the first embodiment, the fixed-side contact 21 is supported by the fixed-aide longitudinal magnetic-field coil 22 not only via the power feeding portion 53, but also via the fixed-side spacers 23 at the locations where the fixed-side spacers 213 are placed so that the fixed-side contact 21 can be stably supported. Similarly, in the vacuums valve 10 according to the first embodiment, the movable-side contact 31 is supported by the movable-side longitudinal magnetic-field coil 32 not only via the power feeding portion 53, but also via the movable-side spacers 33 at the locations where the movable-aide spacers 33 are placed, so that the movable-side contact 31 can be stably supported. In the vacuum valve 10 according to the first, embodiment, the fixed-side contact 21 is stably supported by the fixed-side longitudinal magnetic-field coil 22, and the movable-side contact 31 is stably supported by the movable-side longitudinal magnetic-field coil 32. Therefore, the fixed-side contact 21 and the movable-side contact 31 do not tend to tilt at the time of assembly, so that assembly is easier.

In the vacuum valve 10 according to the first embodiment, the single slit 57 is provided for the fixed-side longitudinal magnetic-field coil 22, and each of the fixed-aide spacers 23 is made of an insulator or metal material having a lover electric conductivity than the fixed-aide longitudinal magnetic-field coil 22. Therefore, it is possible to generate a strong axial magnetic field on substantially the entire circumference of the fixed-side contact 21 except for a portion around the slit 57. Similarly, in the vacuum valve 10 according to the first embodiment, the single slit 57 is provided for the movable-side longitudinal magnetic-field coil 32, and each of the movable-side spacers 33 is made of an insulator or metal material having a lover electric conductivity than the movable-side longitudinal magnetic-field coil 32. Therefore, it is possible to generate a strong axial magnetic field on substantially the entire circumference of the movable-side contact 31 except for a portion around the slit 57. As a result, the vacuum valve 10 according to the first embodiment can enhance electric current interruption performance.

In the vacuum valve 10 according to the first embodiment the fixed-side contact 21 and the fixed-side longitudinal magnetic-field coil 22 are fixed via the fixed-side spacers 23, and the movable-side contact 31 and the movable-side longitudinal magnetic-field coil 32 are fixed via the movable-side spacers 33. Therefore, in the vacuum valve 10 according to the first embodiment, even if the brazing material joining the fixed-side contact 21 and the fixed-side longitudinal magnetic-field coil 22 or the brazing material joining the movable-side contact 31 and the movable-side longitudinal magnetic-field coil 32 is remelted at the time of final brazing, the fixed-side contact 21 does not come off the fixed-side longitudinal magnetic-field coil 22, and the movable-side contact 31 does not come off the movable-side longitudinal magnetic-field coil 32, so that yield can be improved.

Furthermore, in the vacuum valve 10 according to the first embodiment, the fixed-side spacers 23 and the movable-side spacers 33 are fixed by means of swaging of the ridges S5 and 56, not by means of brazing: Therefore, even when each of the fixed-side spacers 23 is made of metal with lower electric conductivity than the fixed-aide longitudinal magnetic-field coil 22, or even when each of the movable-side spacers 33 is made of metal with lower electric conductivity than the movable-side longitudinal magnetic-field coil 32, some contact resistance is generated between the fixed-side spacer 23 and the fixed-side longitudinal magnetic-field coil 22, between the fixed-side spacer 23 and the fixed-side contact 21, between the movable-side spacer 33 and the movable-side longitudinal magnetic-field coil 32, and between the movable-side spacer 33 and the movable-side contact 31. Consequently, the vacuum valve 10 according to the first embodiment can reduce a leakage current that passes through the fixed-side spacers 23 and a leakage current that passes through the movable-side spacers 33, and improve electric current interruption performance.

In addition, since the fixed side contact 21, the movable-side contact 31, the fixed-side longitudinal magnetic-field coil 22, and the movable-side longitudinal magnetic-field coil 32 are made by like-shaving processing such as rotary cutting and lathe turning, machining cost does not increase even if the ridges 55 and 56 are provided. In addition, since the fixed-side longitudinal magnetic-field coil 22 and the movable-side longitudinal magnetic-field coil 32 each include only one outer ring portion 52, the fixed-side longitudinal magnetic-field coil 22 and the movable-side longitudinal magnetic-field coil 32 can be created with a small number of processing steps. Furthermore, it is possible to easily make the fixed-side spacers 23 and the movable-side spacers 33 just by dividing a ring having an H-shaped cross section.

### Second Embodiment

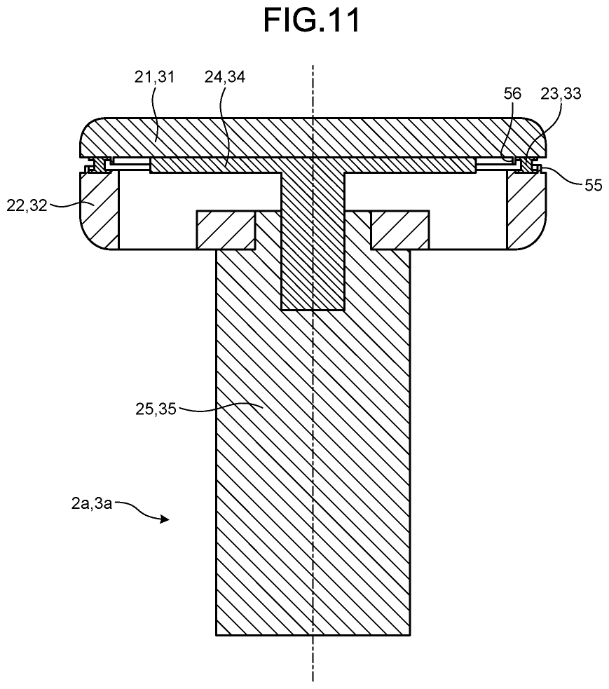

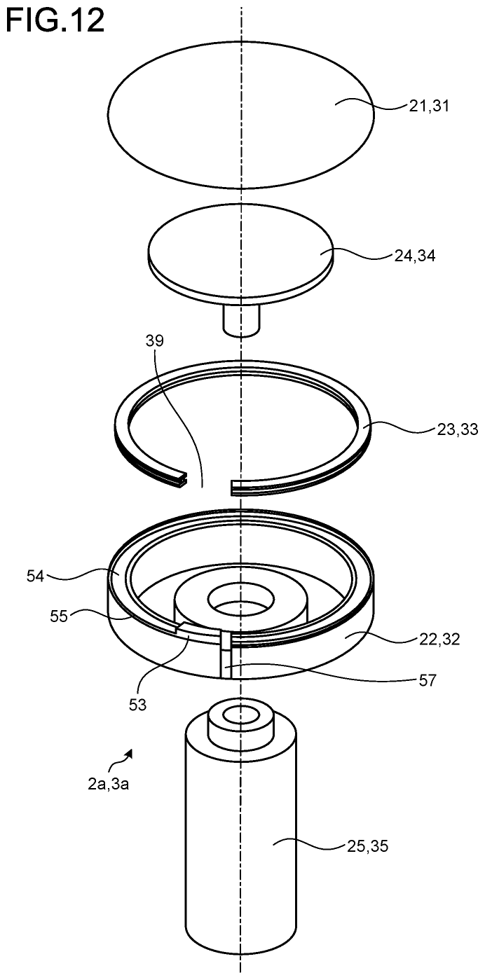

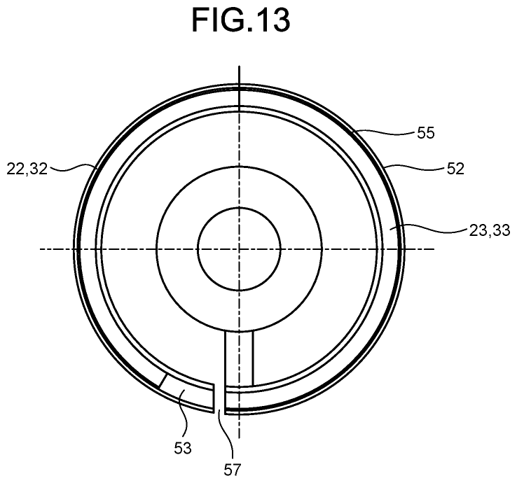

FIG. 11 is a cross-sectional view of an electrode unit of a vacuum valve according to a second embodiment. FIG. 12 is an exploded perspective view of the electrode unit of the vacuums valve according to the second embodiment. FIG. 13 is a diagram illustrating a state in which a fixed-side spacer has been attached to a fixed-side longitudinal magnetic-field coil of the vacuum valve according to the second embodiment and a state in which a movable-side spacer has been attached to a movable-side longitudinal magnetic-field coil of the same. In the vacuum valve 10 according to the second embodiment, the fixed-side spacer 23 and, the movable-side spacer 33 have each the shape of a ring that is partially missing to form a single absent portion 39 in which the power feeding portion 53 is to be set. Except for this point, the vacuum valve 10 according to the second embodiment is substantially the same as the vacuum valve 10 according to the first embodiment.

In the vacuum valve 10 according to the second embodiment, it is possible to easily make the fixed-side spacer 23 and the movable-side spacer 33 by cutting a pipe material having been subjected to slit processing so that manufacturing cost can be reduced. In addition, since the fixed-side spacer 23 and the movable-side spacer 33 are each singularly provided, it is possible to reduce the number of man-hours for a work of fixing the fixed-side spacer 23 to the fixed-side longitudinal magnetic-field coil 22 and a work of fixing the movable-side spacer 33 to the movable-side longitudinal magnetic-field coil 32. In addition, the vacuum valve 10 according to the second embodiment can achieve substantially the same effects as those of the vacuum valve 10 according to the first embodiment.

### Third Embodiment

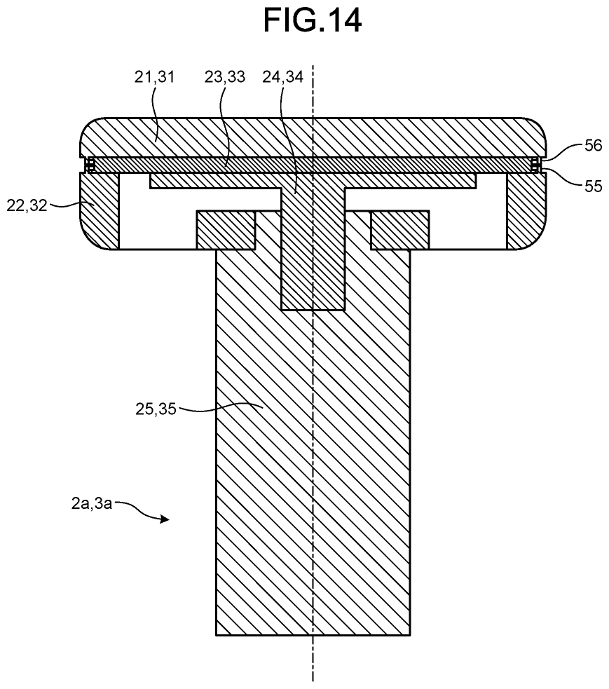

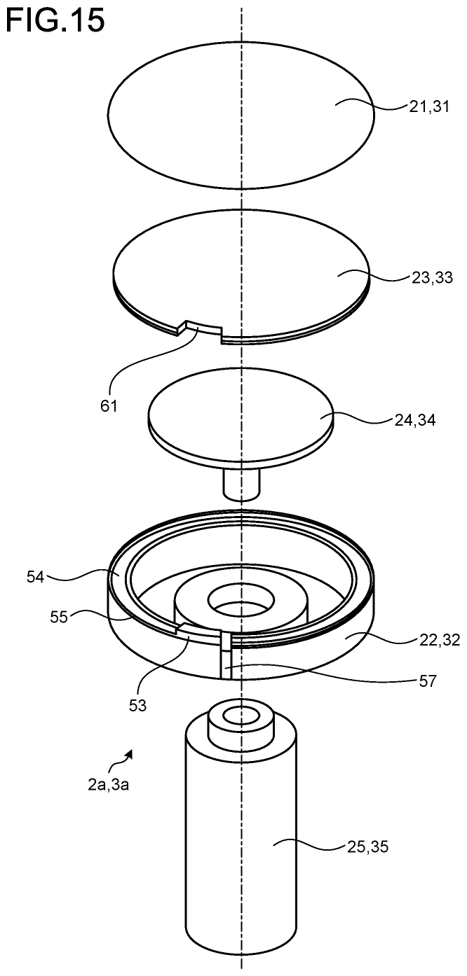

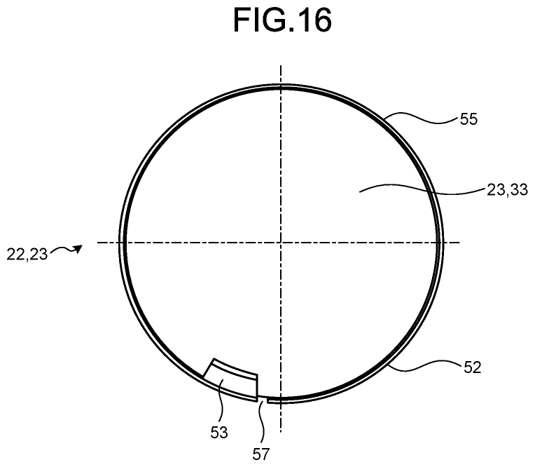

FIG. 14 is a cross-sectional view of an electrode unit of a vacuum valve according to a third embodiment. FIG. 15 is an exploded perspective view of the electrode unit of the vacuum valve according to the third embodiment. FIG. 16 is a diagram illustrating a state in which a fixed-side spacer has been attached to a fixed-side longitudinal magnetic-field coil of the vacuum valve according to the third embodiment and a state in which a movable-side spacer has been attached to a movable-side longitudinal magnetic-field coil of the same. In the vacuum valve 10 according to the third embodiment, the fixed-side spacer 23 and the movable-side spacer 33 each have a circular disk shape in which a cut-away portion 61 is formed, the power feeding portion 53 is to be set in the cut-away portion 61. In the vacuum valve 10 according to the third embodiment, since the fixed-side spacer 23 is disposed between the fixed-side contact 21 and the fixed-side support 24, the fixed-side support 24 and the fixed-side contact 21 are not in contact with each other. Furthermore, since the movable-side spacer 33 is disposed between the movable-side contact 31 and the movable-side support 34, the movable-side support. 34 and the movable-side contact 31 are not in contact with each other Except for this point, the vacuum valve 10 according to this embodiment is substantially the same as the vacuum valve 10 according to the first embodiment.

In the vacuum valve 10 according to the third embodiment, it is possible to easily make the fixed-side spacer 23 and the movable-side spacer 33 by cutting a grooved bar material or by forming the cut-away portion 61 in a disk by press working, so that manufacturing cost can be reduced. In addition, since the fixed-side spacer 23 and the movable-side spacer 33 are each singularly provided, it is possible to reduce the number of man-hours for a work of fixing the fixed-side spacer 23 to the fixed-side longitudinal magnetic-field coil 22 and a work of fixing the movable-side spacer 33 to the movable-side longitudinal magnetic-field coil In addition, the vacuum valve 10 according to the third embodiment can achieve substantially the same effects as those of the vacuum valve 10 according to the first embodiment.

The configurations set forth in the above embodiments show just, examples of the contents of the present disclosure, and it is possible to combine each of these configurations with other publicly known techniques, and also possible to omit and/or modify a part of each of the configurations without departing from the scope of the present disclosure.

### REFERENCE SIGNS LIST

1 insulation container; 2 fixed-side electrode; 2a, 3a electrode unit; 3 movable-side electrode; 4 guide; 5 shield; 10 vacuum valve; 21 fixed-side contact; 22 fixed-side longitudinal magnetic-field coil; 23 fixed-side spacer; 24 fixed aide support; 25 fixed-side electrode rod; 26 fixed-side end plate; 31 movable-side contact; 32 movable-side longitudinal magnetic-field coil; 33 movable-side spacer; 34 movable-side support; 35 movable-side electrode rod; 36 bellows cover; 37 bellows; 38 movable-side end plate; 39 absent portion; 41 disk portion; 42 shaft portion; 51 spoke portion; 52 outer ring portion; 53 power feeding portion; 54 groove; 55, 56 ridge; 57 slit; 58 inner ring portion; 61 cut-away portion.

1. A vacuum valve comprising:
an insulation container with a cylindrical shape; and
a fixed-side electrode and a movable-side electrode installed on a central axis of the insulation container in such a way as to face each other, wherein
the fixed-side electrode includes a fixed-side contact, a fixed-side longitudinal magnetic-field coil, and a fixed-side spacer, the fixed-side longitudinal magnetic-field coil generating a magnetic field on a surface of the fixed-side contact in an axial direction of the insulation container, the fixed-side spacer filling a gap between the fixed-side contact and the fixed-side longitudinal magnetic-field coil,
the movable-side electrode includes a movable-side contact, a movable-side longitudinal magnetic-field coil, and a movable-side spacer, the movable-side longitudinal magnetic-field coil generating a magnetic field on a surface of the movable-side contact in the axial direction of the insulation container, the movable-side spacer filling a gap between the movable-side contact and the movable-side longitudinal magnetic-field coil,
the fixed-side longitudinal magnetic-field coil and the movable-side longitudinal magnetic-field coil each include an inner ring portion, a spoke portion, an outer ring portion, and a power feeding portion, the inner ring portion being disposed at a central part of the insulation container in a radial direction, the spoke portion extending from the inner ring portion in the radial direction of the insulation container, the outer ring portion extending in an arc shape in a circumferential direction of the insulation container, an end of the outer ring portion being separated from the spoke portion by a slit extending along the radial direction of the insulation container, the power feeding portion protruding from the end in the axial direction of the insulation container, the fixed-side contact or the movable-side contact being brazed to the power feeding portion,
the fixed-side spacer and the movable-side spacer are made of a material having a lower electric conductivity than a material of the fixed-side longitudinal magnetic-field coil and a material having a lower electric conductivity than a material of the movable-side longitudinal magnetic-field coil, respectively, or made of an insulator, each of the fixed-side spacer and the movable-side spacer being installed on at least one portion of the outer ring portion,
the fixed-side spacer engages with both the fixed-side contact and the fixed-side longitudinal magnetic-field coil,
the movable-side spacer engages with both the movable-side contact and the movable-side longitudinal magnetic-field coil,
a ridge is formed on each of the fixed-side contact, the fixed-side longitudinal magnetic-field coil, the movable-side contact, and the movable-side longitudinal magnetic-field coil, the fixed-side spacer is fixed by swaging of the ridge of each of the fixed-side contact and the fixed-side longitudinal magnetic-field coil, and
the movable-side spacer is fixed by swaging of the ridge of each of the movable-side contact and the movable-side longitudinal magnetic-field coil.

2-3. (canceled)

4. The vacuum valve according to claim 1, wherein the fixed-side spacer and the movable-side spacer each have a disk shape in which a cut-away portion is formed, the power feeding portion being to be set in the cut-away portion.

5. The vacuum valve according to claim 1, wherein the fixed-side spacer and the movable-side spacer have each a shape of a ring that is partially missing to form a single absent portion in which the power feeding portion is to be set.

6. The vacuum valve according to claim 1, wherein at least one fixed-side spacer is disposed on the outer ring portion of the fixed-side longitudinal magnetic-field coil, and at least one movable-side spacer is disposed on the outer ring portion of the movable-side longitudinal magnetic-field coil, the fixed-side spacer and the movable-side spacer each having a block shape.

7. The vacuum valve according to claim 5, wherein the fixed-side spacer and the movable-side spacer are each embedded in a groove provided in the outer ring portion.

8. The vacuum valve according to claim 6, wherein the fixed-side spacer and the movable-side spacer are each embedded in a groove provided in the outer ring portion.

9. A vacuum valve comprising:
an insulation container with a cylindrical shape; and
a fixed-side electrode and a movable-side electrode installed on a central axis of the insulation container in such a way as to face each other, wherein
the fixed-side electrode includes a fixed-side contact, a fixed-side longitudinal magnetic-field coil, and a fixed-side spacer, the fixed-side longitudinal magnetic-field coil generating a magnetic field on a surface of the fixed-side contact in an axial direction of the insulation container, the fixed-side spacer filling a gap between the fixed-side contact and the fixed-side longitudinal magnetic-field coil,
the movable-side electrode includes a movable-side contact, a movable-side longitudinal magnetic-field coil, and a movable-side spacer, the movable-side longitudinal magnetic-field coil generating a magnetic field on a surface of the movable-side contact in the axial direction of the insulation container, the movable-side spacer filling a gap between the movable-side contact and the movable-side longitudinal magnetic-field coil,
the fixed-side longitudinal magnetic-field coil and the movable-side longitudinal magnetic-field coil each include an inner ring portion, a spoke portion, an outer ring portion, and a power feeding portion, the inner ring portion being disposed at a central part of the insulation container in a radial direction, the spoke portion extending from the inner ring portion in the radial direction of the insulation container, the outer ring portion extending in an arc shape in a circumferential direction of the insulation container, an end of the outer ring portion being separated from the spoke portion by a slit extending along the radial direction of the insulation container, the power feeding portion protruding from the end in the axial direction of the insulation container, the fixed-side contact or the movable-side contact being brazed to the power feeding portion,
the fixed-side spacer and the movable-side spacer are made of a material having a lower electric conductivity than a material of the fixed-side longitudinal magnetic-field coil and a material having a lower electric conductivity than a material of the movable-side longitudinal magnetic-field coil, respectively, or made of an insulator, each of the fixed-side spacer and the movable-side spacer being installed on at least one portion of the outer ring portion, and
the fixed-side spacer and the movable-side spacer each have a disk shape in which a cut-away portion is formed, the power feeding portion being to be set in the cut-away portion.

10. A vacuum valve comprising:
an insulation container with a cylindrical shape; and
a fixed-side electrode and a movable-side electrode installed on a central axis of the insulation container in such a way as to face each other, wherein
the fixed-side electrode includes a fixed-side contact, a fixed-side longitudinal magnetic-field coil, and a fixed-side spacer, the fixed-side longitudinal magnetic-field coil generating a magnetic field on a surface of the fixed-side contact in an axial direction of the insulation container, the fixed-side spacer filling a gap between the fixed-side contact and the fixed-side longitudinal magnetic-field coil,
the movable-side electrode includes a movable-side contact, a movable-side longitudinal magnetic-field coil, and a movable-side spacer, the movable-side longitudinal magnetic-field coil generating a magnetic field on a surface of the movable-side contact in the axial direction of the insulation container, the movable-side spacer filling a gap between the movable-side contact and the movable-side longitudinal magnetic-field coil,
the fixed-side longitudinal magnetic-field coil and the movable-side longitudinal magnetic-field coil each include an inner ring portion, a spoke portion, an outer ring portion, and a power feeding portion, the inner ring portion being disposed at a central part of the insulation container in a radial direction, the spoke portion extending from the inner ring portion in the radial direction of the insulation container, the outer ring portion extending in an arc shape in a circumferential direction of the insulation container, an end of the outer ring portion being separated from the spoke portion by a slit extending along the radial direction of the insulation container, the power feeding portion protruding from the end in the axial direction of the insulation container, the fixed-side contact or the movable-side contact being brazed to the power feeding portion,
the fixed-side spacer and the movable-side spacer are made of a material having a lower electric conductivity than a material of the fixed-side longitudinal magnetic-field coil and a material having a lower electric conductivity than a material of the movable-side longitudinal magnetic-field coil, respectively, or made of an insulator, each of the fixed-side spacer and the movable-side spacer being installed on at least one portion of the outer ring portion, and
the fixed-side spacer and the movable-side spacer have each a shape of a ring that is partially missing to form a single absent portion in which the power feeding portion is to be set.
